(19) United States
(12) Patent Application Publication
(10) Pub. No.: US 2015/0009704 A1
(43) Pub. Date: Jan. 8, 2015

(54) Fiber-optic illumination system

(71) Applicants: Monica Denise Knight, Gulfport, MS (US); Tracy Bernadette Malley, Gulfport, MS (US)

(72) Inventors: Monica Denise Knight, Gulfport, MS (US); Tracy Bernadette Malley, Gulfport, MS (US)

(21) Appl. No.: 14/324,687

(22) Filed: Jul. 7, 2014

Related U.S. Application Data
(60) Provisional application No. 61/843,031, filed on Jul. 4, 2013.

(51) Int. Cl. F21V 8/00; G02B 6/04

(52) U.S. Cl. CPC G02B 6/0006; G02B 6/04
USPC 362/554; 362/583; 362/551

(57) ABSTRACT

A fiber-optic illumination system provides lighting via a small number of low energy lighting elements, from which light is transmitted via fiber optic cables to the specific locations where illumination is needed. Low energy light elements, such as LEDs may be housed centrally at an illuminator with light distributed to where illumination is needed via fiber optic cables, resulting in reduced energy costs and simplified system maintenance.

### CROSS-REFERENCE TO RELATED APPLICATIONS

This application claims priority to U.S. Provisional Application No. 61/843031, filed Jul. 4, 2013, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to lighting systems and in particular to a fiber-optic illumination system. With the steady increase in energy costs, and more increases to come, both homeowners and business managers are seeking innovative ways to maintain and reduce the costs of illuminating interior rooms. A fiber-optic system for providing lighting in a room, such as in a workplace or home, would satisfy this demand by implementing a system that avoids the problem of high energy consumption by multiple lighting instruments. Because the energy used is limited by providing a small number of lighting instruments, from which light is transmitted via fiber optic conduits to the specific locations where illumination is needed. The reduction in the number of lighting instruments, regardless of the energy source or light generation method used, results in an energy savings because fixed energy costs for each lighting element are reduced.

### SUMMARY OF THE INVENTION

Accordingly, the invention is directed to a fiber-optic illumination system. The system provides lighting via a small number of low energy lighting elements, from which light is transmitted via fiber optic cables to the specific locations where illumination is needed. Low energy light elements, such as LEDs may be housed centrally at an illuminator with light distributed to where illumination is needed via fiber optic cables, resulting in reduced energy costs and simplified system maintenance.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 shows a perspective view of a conduit component of the first exemplary embodiment, displaying the conduit 10, the optical fibers 11, and the insulation 12.

FIG. 2 shows a side view of a light fixture component of the first exemplary embodiment, displaying the light fixture 13.

FIG. 3 shows a perspective view of the first exemplary embodiment installed in a commercial building, displaying the light fixtures 13.

FIG. 4 shows a perspective view of the first exemplary embodiment installed in an industrial building, displaying the light fixtures 13.

FIG. 5 shows a perspective view of the first exemplary embodiment installed in a residential building, displaying the light fixture 13.

FIG. 6 shows a side transparency view of the illuminator component of the first exemplary embodiment, displaying the illuminator 60, access door 61, key lock 62, hinges 63, light sources 64, reflectors 65, focusing lenses 66, filters 67, connectors 68, and fiber optic assemblies 69.

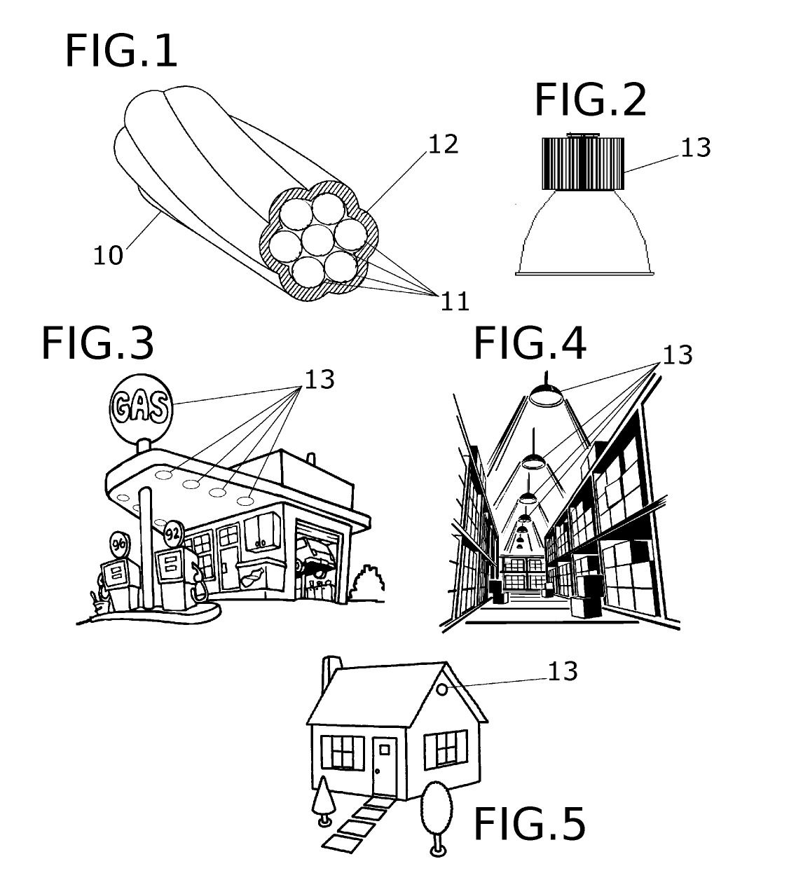

### DETAILED DESCRIPTION OF THE INVENTION

Referring now to the invention in more detail, the invention is directed to a fiber-optic illumination system. The system provides illumination where needed and avoids the problem of high energy consumption by multiple lighting instruments. Illumination is provided by a small number of low energy lighting instruments, from which light is transmitted via fiber optic conduits 10 to the specific locations where illumination is needed. The reduction in the number of lighting instruments, regardless of the energy source or light generation method used, results in an energy savings because fixed energy costs for each lighting fixture 13 are reduced.

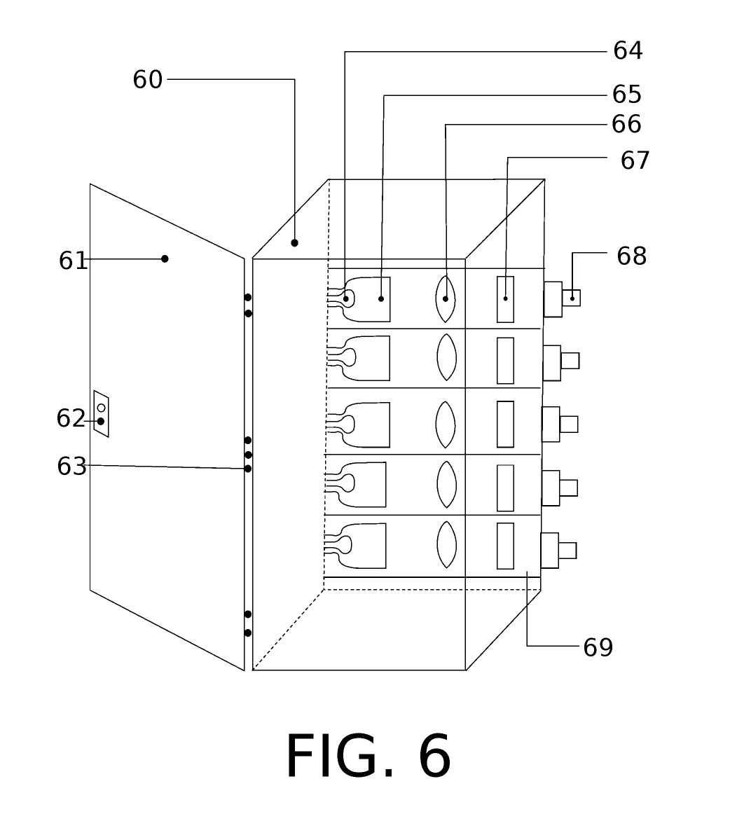

The system consists of three types of components: the central light source component (preferably the illuminator 60, shown in FIG. 6), a plurality of conduit components 10, and a plurality of light fixture components 13. The illuminator 60 component is the source of light for the entire system, and is the only component that consumes electric power. The illuminator component 60 would preferably feature a plurality of light creation levels, and the light creation levels would preferably be controlled by a selector switch and a dimmer switch. Each conduit component consists of a conduit 10, featuring a plurality of optical fibers 11, encased in insulation 12. In the preferred embodiment, the optical fibers 11 are five in number, such that one conduit 10 may be linked with one illuminator 60 having five light sources 64. The interior surface of the insulation 12 and the central light source component would preferably be reflective, so that no light is absorbed and lost during transmission from the central light source component.

The light fixture components consist of a variety of functional and decorative light fixtures 13, providing illumination with fiber optics carrying light from the illuminator component 60, rather than providing light sources of their own with fluorescent or incandescent light bulbs. Each light fixture component would feature its own on/off switch and other controls as desired.

The illuminator 60 is preferably constructed as an oblong housing with preferable dimensions thirty-six inches tall by eighteen inches wide by twenty-four inches deep. The illuminator 60 may be constructed of a durable weather resistant material for installation on the exterior of a building. The illuminator 60 may be made selectively accessible by allowing one side to open as a door 61 on hinges 63 and secured by a key lock 62. Within the illuminator is a plurality of optical assemblies 69. The optical assemblies 69 preferably provide a series of optical components in inline configuration. The optical assemblies 59 are five in number in the preferred embodiment. Each optical assembly comprises a high luminosity and low energy light source 64, such as a light emitting diode (LED) or an array of LEDs. The low energy light source 64 sits at or near the focal point of a reflector 65. The reflector 65 is preferably a parabolic reflector such that emitted light is substantially collimated. A lens 66 focuses the emitted light about at the input into one of the fibers 11 of the conduit 10 at a connector 68. Preferably between the lens 66 and connector 68, the emitted light may be passed through a filter 67, which is preferably configured to block light in the harmful ultraviolet light band and in the warming infrared bands, or any other non-visible band considered undesirable. The filter 67 may be limited in applicability or omitted entirely where the light source 64 does not emit light in particular bands. The connectors 68 are configured so as to accept individual optical fibers 11 from the conduits 10, which may be broken out of their bundle at the illuminator 60.

Referring now to the optical fibers 11, the Inventors have observed that fibers 11 having a large core diameter are strongly preferable. Preferred core diameters are on the order of 100 μm, with a preferable minimum of 350 μm. Glass fibers are preferred to other fiber materials, for example acrylic. The inventors have observed that large diameter fibers are of limited or non-existent commercial availability, and have observed that compound optical fibers 11 made up of many small diameter readily commercially available fibers on the order of 1 μm-10 μm core diameter range.

To use the system, the user selects the overall level of light to be created with the selector switch and the dimmer switch on the central light source component. The user then directs light to the light fixtures 13 via the conduits 10, by using the on/off switches and other controls physically associated with the light fixtures 13.

The optical fibers 11 would preferably be manufactured from a durable, flexible, light-transmitting material, preferably glass. The insulation 12 would preferably be manufactured from a durable, flexible material such as plastic, lined on its interior surface with a flexible, reflective film such as biaxially-oriented polyethylene terephthalate. The central light source component and light fixture components would preferably be manufactured from durable, rigid, functional or decorative materials, such as wood, plastic, steel, aluminum, brass, and malacrylate.

Components and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A fiber optic illumination system comprising an illuminator component, a conduit component, and a light fixture component; said illuminator component comprising a plurality of low energy light sources; said plurality of low energy light source components being in optical communication with said conduit component; said conduit component comprising a plurality of optical fibers; said conduit component being in optical communication with said light fixture component, whereby light may be transferred from said illuminator component to said light fixture component.

2. The fiber optic illumination system of claim 1 wherein each of said plurality of optical fibers is composed of a single optical fiber having a core diameter at least 350 μm.

3. The optical fiber illumination system of claim 1 wherein each of said plurality of optical fibers comprises a bundle of small core diameter optical fibers.

4. The fiber optic illumination system of claim 1 wherein said illuminator component comprises a plurality of fiber optic assemblies; said plurality of fiber optic assemblies being equal in number to said plurality of optical fibers and to said plurality of low energy light source components.

5. The fiber optic illumination system of claim 4 wherein each of said optical assemblies comprises one of said plurality of low energy light source components; a reflector; a lens; a connector; said one of said plurality of low energy light source components being positioned about at the focal point of said reflector such that light emitted from said low energy light source is substantially directed to said lens; said lens being configured such that light directed at it is substantially focused about at said connector; said connector being configured to accept into optical communication one of said plurality of optical fibers.

6. The fiber optic illumination system of claim 5 wherein each of said optical assemblies further comprises a filter; said filter being configured to block at least one range of frequencies selected from the group of ranges of ultraviolet light, infrared light, and other non-visible light.

7. The fiber optic illumination system of claim 5 wherein said plurality of optical assemblies, said plurality of optical fibers, and said light fixture component are all five in number.

8. The fiber optic illumination system of claim 5 wherein said illuminator component is constructed of a weather resistant material.

9. The fiber optic illumination system of claim 6 wherein said plurality of optical assemblies, said plurality of optical fibers, and said light fixture component are all five in number.

10. The fiber optic illumination system of claim 6 wherein said illuminator component is constructed of a weather resistant material.

11. The fiber optic illumination system of claim 9 wherein said illuminator component is constructed of a weather resistant material.

12. The fiber optic illumination system of claim 5 wherein each of said plurality of optical fibers is composed of a single optical fiber having a core diameter at least 350 μm.

13. The optical fiber illumination system of claim 5 wherein each of said plurality of optical fibers comprises a bundle of small core diameter optical fibers.

14. The fiber optic illumination system of claim 11 wherein each of said plurality of optical fibers is composed of a single optical fiber having a core diameter at least 350 μm.

15. The optical fiber illumination system of claim 11 wherein each of said plurality of optical fibers comprises a bundle of small core diameter optical fibers.

16. The fiber optic illumination system of claim 6 wherein each of said plurality of optical fibers is composed of a single optical fiber having a core diameter at least 350 μm.

17. The optical fiber illumination system of claim 6 wherein each of said plurality of optical fibers comprises a bundle of small core diameter optical fibers.

18. The fiber optic illumination system of claim 7 wherein each of said plurality of optical fibers is composed of a single optical fiber having a core diameter at least 350 μm.

19. The optical fiber illumination system of claim 7 wherein each of said plurality of optical fibers comprises a bundle of small core diameter optical fibers.

20. The fiber optic illumination system of claim 8 wherein each of said plurality of optical fibers is composed of a single optical fiber having a core diameter at least 350 μm.
